(19) United States
(12) Patent Application Publication
(10) Pub. No.: US 2010/0008501 A1
(43) Pub. Date: Jan. 14, 2010

(54) ILLEGAL RECORDING PREVENTION APPARATUS

(75) Inventor: Yoshiki IWASAKI, Kanagawa (JP)

Correspondence Address: RADER FISHMAN & GRAUER PLLC, LION BUILDING, 1233 20TH STREET N.W., SUITE 501, WASHINGTON, DC, 20036, US

(73) Assignee: USHIO DENKI KABUSHIKI KAISHA, Tokyo (JP)

(21) Appl. No.: 12/498,583

(22) Filed: Jul. 7, 2009

(30) Foreign Application Priority Data
Jul. 10, 2008 (JP) 2008-203590
Mar. 26, 2009 (JP) 2009-100347

(51) Int. Cl. H04N 7/167

(52) U.S. Cl. 380/201

(57) ABSTRACT

An illegal recording prevention apparatus used for preventing an illegal recording with a video camera in a movie theater, comprises a unit for emitting infrared light which has a center wavelength in a wavelength of 800-980 nm wavelength, so that an automatic-focusing regulating function or automatic exposure regulating function of the video camera is deteriorated.

### CROSS-REFERENCES TO RELATED APPLICATION

This application claims priority from Japanese Patent Application Serial Nos. 2008-203590 filed Jul. 10, 2008 and 2009-100347 filed Mar. 26, 2009, the contents of which are incorporated herein by reference in their entireties.

### TECHNICAL FIELD

The present invention relates to an illegal recording prevention apparatus. In particular, the present invention pertains to an apparatus used for preventing illegal recording of a film in a movie theater in order to obtain a profit unfairly from the sales of illegally recorded copies of the copyrighted work or the publishing of the film on the Internet etc.

### BACKGROUND

In the 1980s, a so-called pirate video which was made by recording a screen image and audio played in a movie theater or a hall, appeared on the market. This is because an apparatus can be easily carried in such a movie theater due to the spread of home recording sound recorder machines. Although an image or an audio of this kind of illegal copy is inferior in quality to that of the legitimate version, the influences on the box office revenues could not be disregarded since it appeared on the market immediately after a new film was released in movie theaters.

In the 1990s, due to the development of cameras and microphones with higher performance and the miniaturization thereof, the quality of recorded images has become more vivid, and the act of recording a movie in a theater has become more discrete. Furthermore, in place of analog videotapes used as a circulation medium of a pirate copy so far, data copy and transmission means based on digital technologies, such as DVD and the Internet has become widely used. As a result, it became possible to reproduce a copy without degrading the quality, and to circulate copies in a short time all over the world. Consequently, the influences on the box office revenue by circulation of the pirate copies became much more serious. According to preliminary calculation from the Motion Picture Association (MPA) which is the overseas regulating organization of the Motion Picture Association of America, the amount of damage inflicted by pirate copies of Japanese films and foreign films, which were made from the illegal recordings in movie theaters in Japan in 2005 was 18 billion yen. And since the movie box office revenue in Japan in the same year was about 198 billion yen, circulation of pirate copies would have caused about a 10% fall in box office revenue.

On the other hand, “the law concerning prevention of illegal recording of a movie” was enforced on Aug. 30, 2007, and it became possible to prevent the illegal recording in movie theaters by law. However, even if the law is enacted, in fact, there remains a trouble with such a person who illegally records a movie, and the bad influence to the movie audience who is not related to the illegal recording etc. remains. For this reason, developments of apparatuses capable of finding or detecting such an illegal recording have been desired.

Japanese Laid Open Patent No. 2006-258651 teaches a method and an apparatus for detecting an apparatus which makes an unauthorized recording, by detecting light reflected from an image pick-up apparatus lens used for illegal recording, in order to prevent the illegal recording in a movie theater. Moreover, Japanese Laid Open Patent No. 2002-197562 teaches an apparatus and a method in which the existence of a small microphone and a miniature camera used for illegal recording and eavesdropping is detected by infrared radiation. Moreover, Japanese Laid Open Patent No. 2001-313006 teaches a method in which an act of illegally recording the subject itself is prevented by intensively emitting infrared light at which a camera for illegal recording has sensitivity to the camera from a subject, using an optical fiber. Moreover, Japanese Laid Open Patent No. 2003-57753 discloses that a visible light is projected on a screen so that the quality of image obtained from illegal recording is reduced. In this case, watching the original movie appreciation itself will be hampered.

### SUMMARY

In the present invention, without exerting a bad influence on an image put on a screen which innocent people watch in a movie theater, the quality of the image captured by malicious illegal recording is deteriorated, thereby preventing the circulation of an illegal medium.

It is an object of the present invention to offer an apparatus for preventing a person who illegally records a movie in a movie theater, from making unfair profit from sales of the copyrighted work, and for preventing such a person from publishing it on the Internet so as to put an author at a disadvantage.

One of aspect of an embodiment is an illegal recording prevention apparatus used for preventing an illegal recording with a video camera in a movie theater. The illegal recording prevention apparatus comprises means for emitting infrared light which has a center wavelength in a wavelength of 800-980 nm wavelength, so that an automatic-focusing regulating function or automatic exposure regulating function of the video camera is deteriorated.

Another aspect of the embodiment is that the infrared light is emitted intermittently from the illegal recording prevention apparatus.

Still another aspect of the invention is that in the illegal recording prevention apparatus, data is output by controlling intervals of blinking infrared light.

Still another aspect of the embodiment is that in the illegal recording prevention apparatus, remote control data of the video camera is overlapped on the infrared light.

Still another aspect of the embodiment is that the illegal recording prevention apparatus further includes a sensor unit which detects brightness of a theater screen, wherein when the sensor unit judges that the theater screen is dark, the infrared light which has a center wavelength in a 900-980 nm range is emitted, and when the sensor unit judges the theater screen is bright, the infrared light which has a center wavelength in a 800-900 nm range is also emitted in addition thereto.

Still another aspect of the embodiment is that in the illegal recording prevention apparatus, the sensor unit stops detection, in a period when the infrared light is emitted towards the video camera.

Still another aspect of the embodiment is that in the illegal recording prevention apparatus, the infrared light is emitted at a frequency of about 60 Hz during light emission.

Focusing on the nature in which if an optical system of a video camera receives a high intensity infrared light, the automatic-focusing mechanism malfunctions, the present illegal recording prevention apparatus has been made in order to solve the above-mentioned subject. That is, the video camera is brought out of focus compulsorily, thereby making the video image deteriorate to an extent that the video image recorded by illegal recordings in, for example, videotape and a hard disk, cannot be enjoyed. Furthermore, by using the property of a three-primary-color filter of an image sensor used for the video camera, which transmits infrared light to be cut to some extent, invisible and high intensity infrared light is emitted towards seats from a screen, whereby the video image illegally recorded in, for example, videotape and a hard disk is deteriorated to the extent that it cannot be appreciated as in the original.

### BRIEF DESCRIPTION OF DRAWINGS

Other features and advantages of the present illegal recording prevention apparatus will be apparent from the ensuing description, taken in conjunction with the accompanying drawings, in which:

FIG. 1 shows an embodiment of an illegal recording prevention apparatus according to the present invention;

FIG. 2 is a graph showing a characteristic of a typical optical filter used for a video camera;

FIG. 3 schematically shows a movie theater where the illegal recording prevention apparatus according to the present invention is installed;

FIG. 4 show an optical appearance on a video camera;

FIG. 5 shows an image of a light emitting element in a state where halation occurs;

FIG. 6 shows an image of a light emitting element in a state where ghost occurs;

FIG. 7 shows an image on which a blink pattern of infrared light was recorded;

FIG. 8 is an image in which an illegal recording prevention apparatus is not operating, where a doll is visually in focus by an automatic-focusing mechanism of a video camera;

FIG. 9 shows an image taken at the moment an illegal recording prevention apparatus is operated;

FIG. 10 shows an image taken in a state where the illegal recording prevention apparatus was operated and a focal regulating function of a video camera is operated;

FIG. 11 shows an image in a state where the illegal recording prevention apparatus is disabled;

FIG. 12 shows an image in a state at moment where the illegal recording prevention apparatus is operated;

FIG. 13 shows an image in a state where the illegal recording prevention apparatus does not emit the infrared light;

FIG. 14 shows a light emitting device of an illegal recording prevention apparatus;

FIG. 15 shows a timing chart of light emitted from an illegally recording prevention apparatus according to the present invention; and

FIG. 16 shows an example image taken when an illegal recording prevention apparatus is operated.

### DETAILED DESCRIPTION

A description will now be given, referring to embodiments of the present illegal recording prevention apparatus. While the claims are not limited to such embodiments, an appreciation of various aspects of the present flash lamp emitting device is best gained through a discussion of various examples thereof.

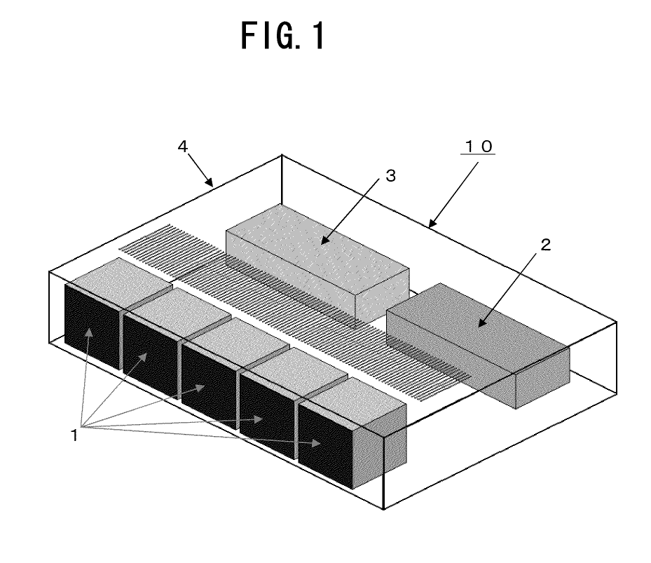

FIG. 1 shows an embodiment of an illegal recording prevention apparatus according to the present invention. An apparatus 10 has a light emission section 1 which emits infrared light, a control unit 2 which controls timing of the light emission, a power supply section 3, and a case 4 which contains these sections. The apparatus 10 is arranged near a screen and emits infrared light towards the seats from the screen side. Moreover, in case of a permeable screen, the infrared light may be emitted from the back side of the screen. In this case, it is advantageous since the audience does not notice the existence of the illegal recording prevention apparatus.

In general, a three-primary-color filter of RGB is used for a video camera. Ideally, this three-primary-color filter is to clearly distinguish an optical area to be transmitted, from an optical area not to be transmitted. Moreover, since a bad influence on the color image of visible light is exerted when light in an infrared range is generated with an image sensor, it is desirable to cut the light in an infrared range completely. However, it is difficult for the actual filter to cut the light in an infrared range completely, thereby letting the light in a little.

The illegal recording prevention apparatus according to the present invention uses the property in which the three-primary-color filter used for a video camera transmits the invisible light of the infrared region which should have been cut. That is, by emitting the light in a range of an infrared region toward a video camera from the screen side by a LED or laser device, the automatic-focusing mechanism or automatic exposure mechanism of the video camera is intentionally adjusted without being seen by the audience.

Here, the image sensors, such as CCD and MOS, are made of silicon. The wavelength which a general image sensor can generate is 400 nm-1000 nm. Although among these, light with the wavelength of 400 nm-700 nm is in a visible range, light with a wavelength of 700 nm-1000 nm is invisible, so that even if such invisible light is projected on a screen, it does not become a hindrance of the played movie for audience at all. That is, although the human being (audience) is not affected at all by light with the wavelength of 700 nm-1000 nm in respect of watching a movie, the image sensor, such as CCD and MOS, can detect such a wavelength. In the present invention, such light in the infrared range is used so as to cause an unnecessary signal or signal saturation to the image sensor. That is, the difference between the sensitivity of human eyes and the detection sensitivity of the image sensor is used to prevent illegal recording by the video camera.

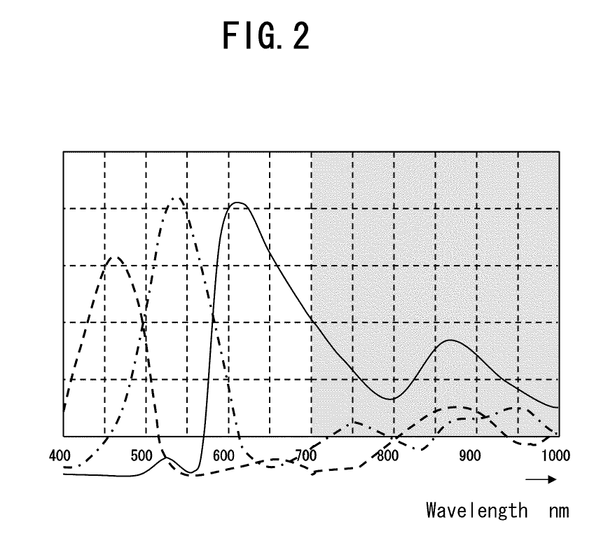

FIG. 2 is a graph showing a characteristic of a typical optical filter used for a video camera. A vertical axis shows relative sensitivity and a horizontal axis shows a wavelength. When an LED is used as a light emitting element, light emission components of light which is emitted from the LED include components of wavelengths longer than a target wavelength and those of wavelengths shorter than the target wavelength. For this reason, since there is a possibility that a red component may interfere with projection of a movie when the central value of light emission wavelength is close to a visible range, it is necessary to select an LED which does not emit light having wavelengths of 700 nm or less. Although the filter of the video camera used for illegal recording has to be take into consideration, it is suitable to use an LED which emits light having the center wavelength in a range of 800 nm-980 nm as a light emitting element of infrared light.

Since the radiation light is invisible, even if the infrared light emitted from the illegal recording prevention apparatus reaches eyes of a viewers, there is no influence on their eyes, either. However, the light which reaches the video camera is recorded on a recording medium of the video camera, since the wavelength of the light is in a range of wavelengths at which the image sensor of the video camera is sensitive. Colors of the infrared light imaged by the video camera vary, depending on a filter of the video camera, and sensitivity of the image sensor. In many cases, all of red, green and blue (RGB) filters have a transmissive component near infrared area, so that the color becomes close to white.

An optical system, such as a lens of a general video camera, an automatic-focusing mechanism, and an automatic exposure mechanism, is optimized based on light of a visible light region. This is because much cost is required in order to extend the applicable range of the optical system to an infrared region. Since a focal position differs between an infrared light area and a visible light area, if an image of a photographic subject at which infrared light is irradiated, is taken by the video camera which is optimized for photographing at a visible light area, the image of the visible light area is deteriorated, causing an out-of-focus image or halation. In order to prevent illegal recording based on this principle, the light of a visible light region, whose intensity is higher than that of light in an infrared range emitted from a light source, that is, i.e., a screen image of a movie projected on the screen, is emitted from near a theater screen. Since the automatic-focusing mechanism of the video camera tries to adjust a focal point with respect to the light of an infrared region, the image on the screen which is illegally recorded by the video camera becomes an out of focus image. As in the automatic-focusing mechanism, the exposure state of the automatic exposure unit becomes out of the optimized exposure state.

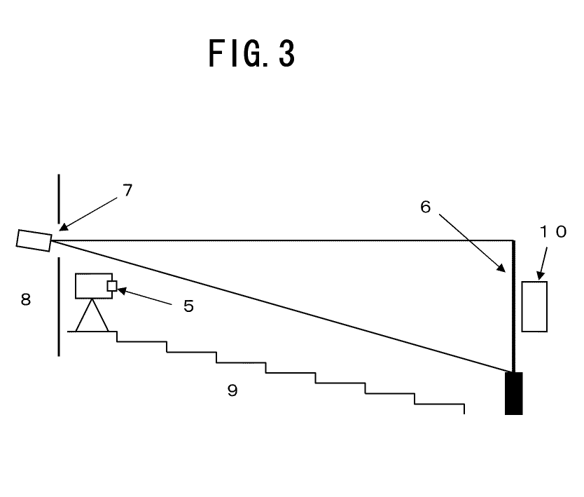

FIG. 3 schematically shows a movie theater having a plurality of seats 9 where an illegal recording prevention apparatus according to the present invention is installed. An image projected on a theater screen 6 from a projector 7 which is provided in a projection booth 8, is illegally recorded by a video camera 5. Infrared light is emitted towards the video camera 5 from an illegal recording prevention apparatus 10 installed in the back side of the screen 6. Since the automatic-focusing mechanism of the video camera 5 which receives the infrared light, tries to adjust a focal point with respect to the light in the infrared range, an image on the screen 6 which is illegally recorded by the video camera becomes out of focus.

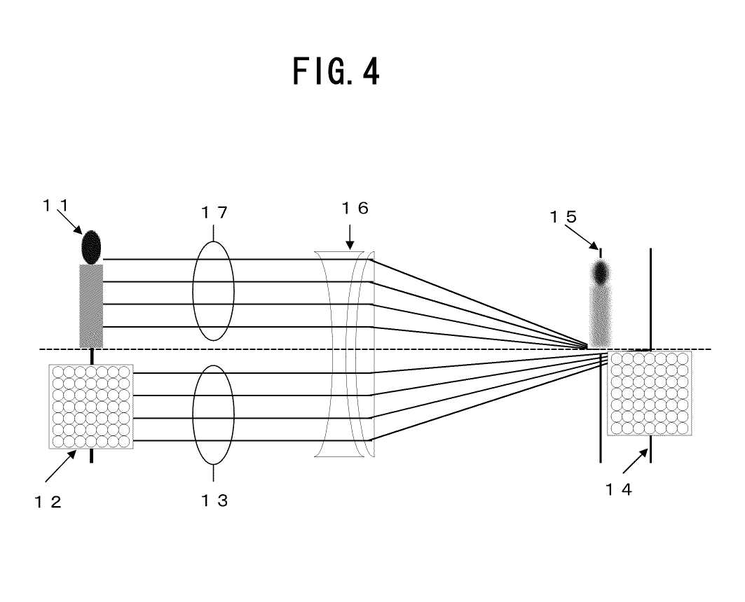

FIG. 4 shows an optical appearance on the video camera 5. The image 11 on the screen and a light emitting device 12 of the illegal recording prevention apparatus are taken with the video camera. An image of the light emitting device 12 is focused on an image sensor 14 through a lens 13 and an automatic-focusing mechanism 16. On the other hand, the image 11 on the screen is also let through a lens 17 and the automatic-focusing mechanism 16, but turns into an image 15 which is out of focus. This is because the video camera 5 operates so as to be focused at the light emitting device 12 of the illegal recording prevention apparatus 10, since the intensity of the infrared light emitted from the light emitting device 12, is higher than that of the image 11 which is projected on the screen. Since, at this time, the wavelength of the visible light and that of the infrared light which is non-visible light are different from each other, the optical focal positions are different from each other. Although the lens 13 and the lens 17 are separately shown for an explanation purpose, in an actual video camera, the lens 13 and the lens 17 are the same member.

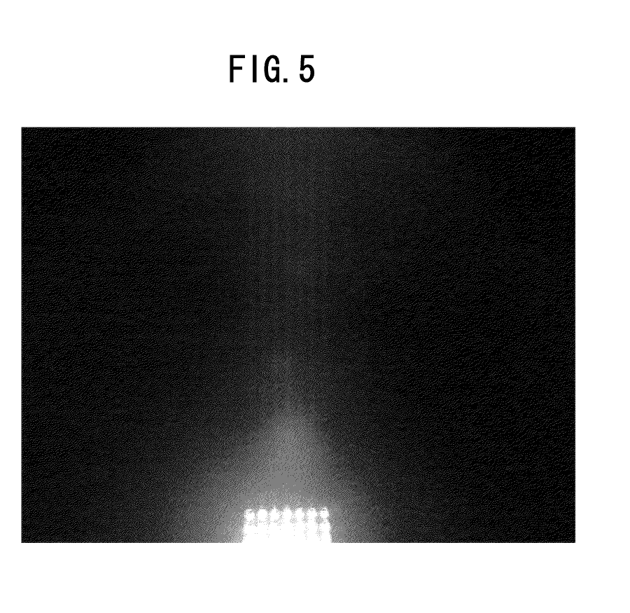

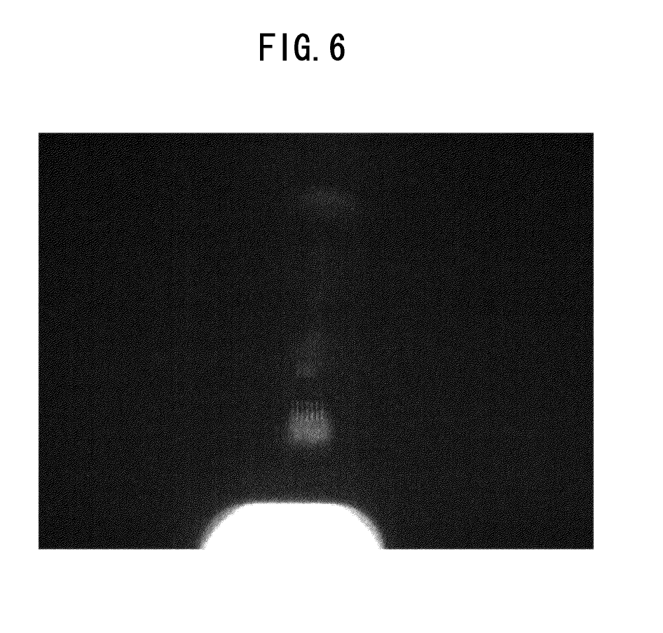

FIGS. 5 and 6 show images of the light emitting device 12 shown in FIG. 4 recorded on the video camera, and show a state where the quality of the illegal recorded image is deteriorated by the illegal recording prevention apparatus according to the present invention. Specifically, FIG. 5 shows a state where halation occurs and FIG. 6 shows a state where ghost occurs. In addition, although FIGS. 5 and. 6 show operational examples of the latest Hi-Vision video camera, even if the illegal recording is made by such a latest video camera, it turns out that there is a great effect in deterioration of the image quality. If the infrared light is intermittently emitted from illegal recording prevention apparatus at this time, the halation or the ghost which is shown in the figure blinks on the screen, so that it is possible to make it more difficult for the viewers to watch the movie.

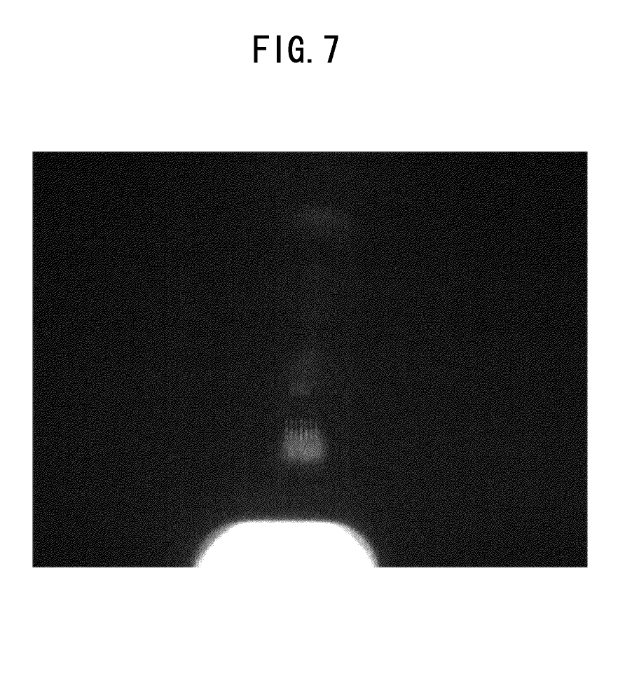

FIG. 7 shows an image on which a blink pattern of infrared light was recorded. In the illegal recording prevention apparatus equipped with an infrared light blinking mechanism, if the infrared light is made so as to cause blinking, it is possible to identify the time, movie theater, screen etc., where the illegal recording was carried out, based on the lighting and lighting-out information obtained from the video image made by the illegal recording, wherein, for example, it is defined as “1” when a lighting period is 2 seconds and a light out period is 2 seconds, and defined as “0” when a lighting period is 2 seconds and a light out period is 4 seconds. Since a film showing schedule of a movie theater in which the illegal recording prevention apparatus is installed is usually known beforehand, if the serial number of the illegal recording prevention apparatus is registered as blink data in the illegal recording prevention apparatus, it is possible to identify the movie theater, screen, etc. where the illegal recording was carried out. Moreover, if calendar, time information, etc. is registered as data in form of intervals of the blinking infrared light, it is possible to obtain the information on, for example, the time when the illegal recording was carried out in more detail.

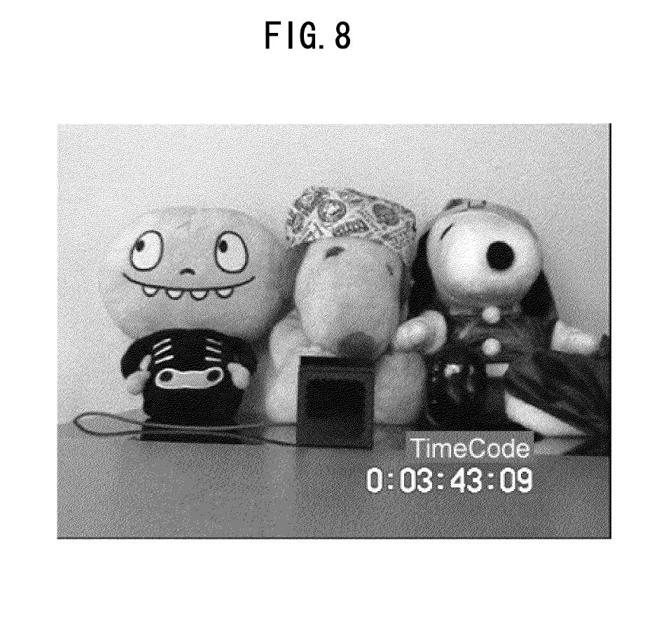

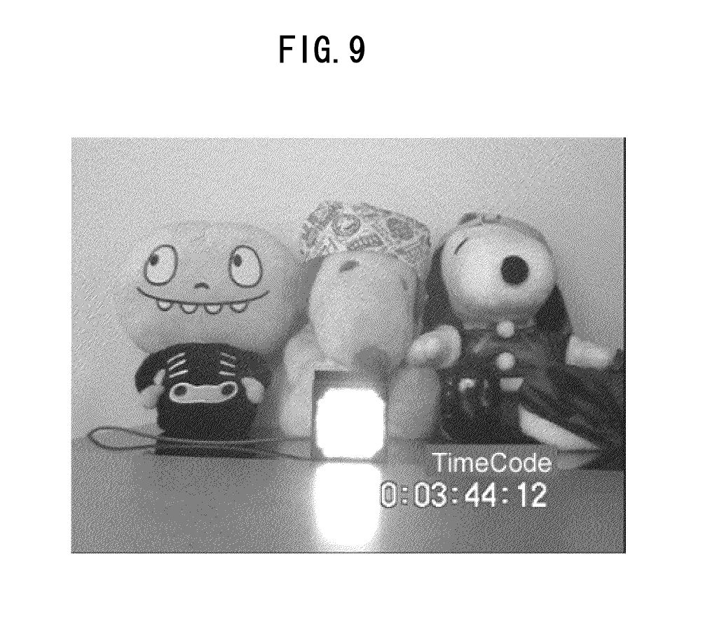

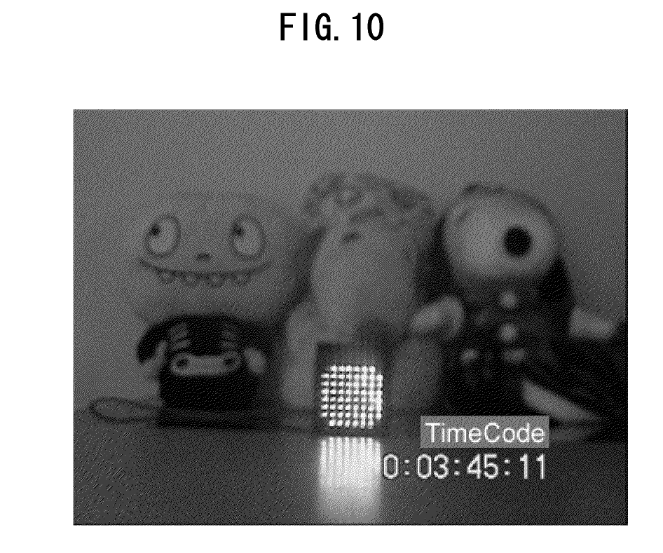

FIGS. 8-10 show images which were recorded by the latest Hi-Vision video camera, respectively, wherein the dolls which were the photographic subject for recording and a light emission section (LED) of the illegal recording prevention apparatus were arranged together. FIG. 8 is an image which was taken where the illegal recording prevention apparatus was not operated, and the dolls are visually in focus by the automatic-focusing mechanism of the video camera. FIG. 9 is an image which was taken at a moment when the illegal recording prevention apparatus is operated. Since the automatic-focusing mechanism of the camera did not follow it, the video camera was focused at the dolls. However, halation occured with momentary light emission and it was hard to compare the image with that of FIG. 9. FIG. 10 shows an image which was taken in a state where the illegal recording prevention apparatus was operated and a focal regulating function of the video camera was also operated. As shown the figure, the dolls which were the subject, were out of focus. Moreover, the light intensity of the infrared light emitted from the illegal recording prevention apparatus was higher than that of surrounding, an automatic iris function of the video camera was operated so that the recorded image becomes dark. This is also an example in which an exposure regulating function of the video camera was deteriorated.

The automatic-focusing mechanism of the video camera is usually designed so as to operate at the time constant of about 1-3 seconds. For this reason, if the illegal recording prevention apparatus is driven so as to blink at intervals of about 1-3 seconds, the automatic-focusing mechanism of the video camera operates so as to always search a new target, thereby acquiring a much more out of focus effect. Moreover, since an exposure function also changes simultaneously, the quality of the illegally recorded image can be deteriorated. This is because it takes time to make focus since it is dark in the movie theater.

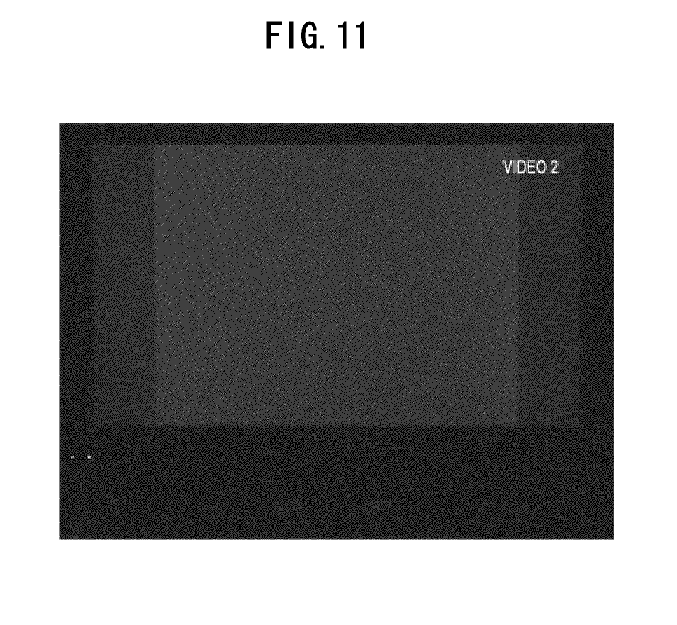

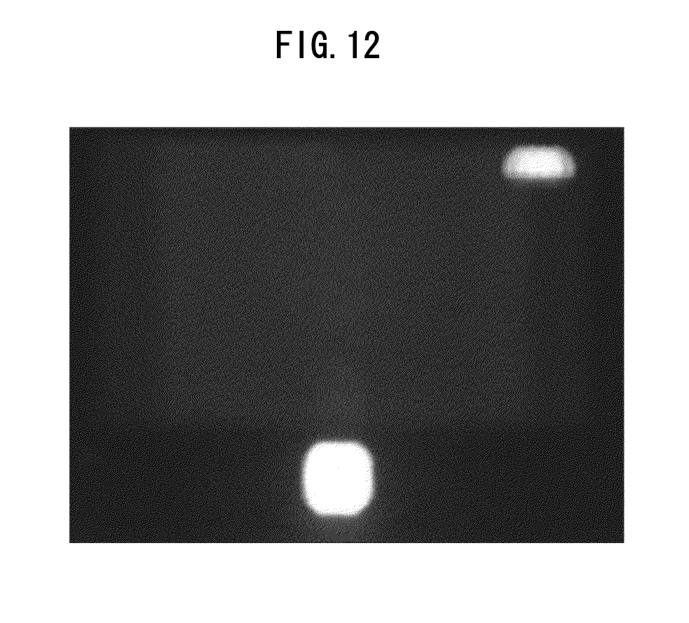

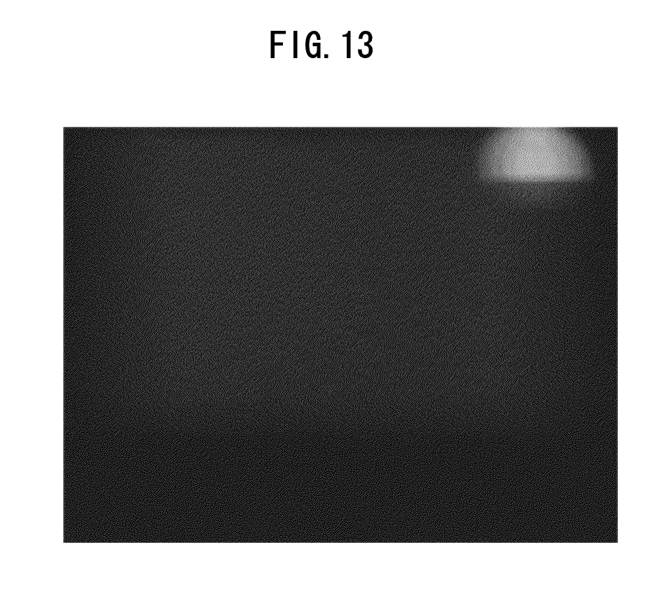

FIGS. 11-13 show imaging states of the video camera where infrared light is blinking. FIG. 11 shows a state where the illegal recording prevention apparatus stopped its operation, wherein the image shown therein was recorded in a state where infrared light did not emit light, so that the screen was in focus. FIG. 12 shows a state at moment where the illegal recording prevention apparatus was operated, that is, infrared light was emitted, wherein since the video camera tried to take the focus at the light source of infrared light, the screen is not focused, whereby the photograph becomes out of focus. FIG. 13 shows a state where the illegal recording prevention apparatus did not emit the infrared light, wherein although the video camera tried to take a focus at a new target, since it was dark therearound, it took time to take the focus, thereby greatly missing the focal point. In addition, if the automatic-focusing mechanism of the video camera is turned off and focusing is manually adjusted, although it may be possible to make the video camera less likely to be affected by the illegal recording prevention apparatus according to the present invention, it is very difficult to manually take the focus, keeping it from being seen by others so that is impractical.

Since the blink information on the captured infrared light can be seen as an image like a visible light on a video camera, if the video image which was illegally recorded is reproduced in slow motion etc., it is possible to easily analyze the place etc. at which illegal recording was carried out, without addition of a specially prepared machine. Similarly, since a halation, or ghost image, etc. of the video camera is caused by infrared light so as to flash on a display, it is possible to analyze the video image illegally recorded by reproducing it in slow motion etc.

Furthermore, a remote control code for the video camera can also be superimposed in the infrared light emitted from the illegal recording prevention apparatus. Specifically, by transmitting a remote control code(s), such as a zoom function, towards the video camera, every several minutes to tens of minutes, not only a recorded video image becomes an undesired image in which magnification thereof is changed periodically, so that the illegally recorded video image cannot be used, but it is also possible to effectively make a person making illegal recording, think that he or she incorrectly operate the video camera. Moreover, it is also effective to transmit a remote control code for stopping a recording in the predetermined time after the movie is put on the screen. In fact, it is possible to use it for many models manufactured by video camera manufactures by transmitting remote control codes therefor.

In order that the power supply of the illegal recording prevention apparatus may be controlled, a microphone is provided inside the illegal recording prevention apparatus, so that if the power supply of the illegal recording prevention apparatus is automatically switched on when the level of volume inside a hall becomes more than a certain level, it is not necessary to provide a power control apparatus outside the illegal recording prevention apparatus, whereby it is possible to reduce the cost of the system. In such a case, since it is not necessary to manually turn on a power supply, it is possible to eliminate a failure to turn on or off, etc., so that labor cost can be saved. If the power supply is controlled so as to be turned on in a fixed period after the level of volume reaches the predetermined level, since the illegal recording prevention apparatus is operated after a movie starts, there is an advantage that the person who illegally makes recording, hardly notices it. If the volume remains at a certain level for a fixed time, it is possible to judge that a movie is over so that the power may be turned off, whereby the power supply can be controlled so as to be automatically turned off.

A photoreceiver is provided outside the illegal recording prevention apparatus in order to control the power supply of the illegal recording prevention apparatus, wherein if the brightness on the screen changes to greater than a certain degree, power is automatically applied to the illegal recording prevention apparatus, so that it is not necessary to provide a power control apparatus outside the illegal recording prevention apparatus, thereby contributing to cost reduction of the system. Moreover, since it is not necessary to manually turn on and off the power supply, it is possible to eliminate a mistake such as a failure to turn on or off, etc., so that labor cost can be saved. After the fluctuation range of the brightness on the screen becomes larger than a predetermined level, if the power supply is controlled to be turned on after a certain fixed period, since the illegal recording prevention apparatus begins to operate after a movie starts, there is an advantage that it is hard for a person making illegal recording to notice that the apparatus is being operated. It is judged that the movie ends where the brightness on the screen remains at a certain level for a certain fixed time or more, and then the power supply is turned off, whereby, the power supply can also be controlled automatically. Moreover, the illegal recording prevention apparatus according to the present invention is equipped with a sensor which detects the brightness of a screen. When the sensor unit judges that the screen is dark, infrared light which has the center wavelength in the 900-980 nm range is emitted, and when it judges that the screen is bright, the infrared light which has the center wavelength in the 800-900 nm range is emitted. A person who makes illegal recording may attaches an infrared light prevention filter to the video camera. In general, this filter has the property of attenuating an infrared light component, while not attenuating a visible light component so much. This is because the effect of the illegal recording prevention will be reduced if such a filter is used where the illegal recording prevention apparatus emits the infrared light having the center wavelength in the 900-980 nm range. On the other hand, when the illegal recording prevention apparatus emits the infrared light having the center wavelength in the 800-900 nm range, it is not reduced by the filter, but when an image projected on the screen is dark, the infrared light may be viewed by the audience of the movie, it may become an obstacle of watching the movie.

For this reason, the infrared light which has the center wavelength in the 900-980 nm range, and which has almost no wavelength components of light visible to human's eyes, is usually emitted from the illegal recording prevention apparatus. Where the screen becomes bright, in addition to that infrared light, infrared light which has the center wavelength in the 800-900 nm range is emitted.

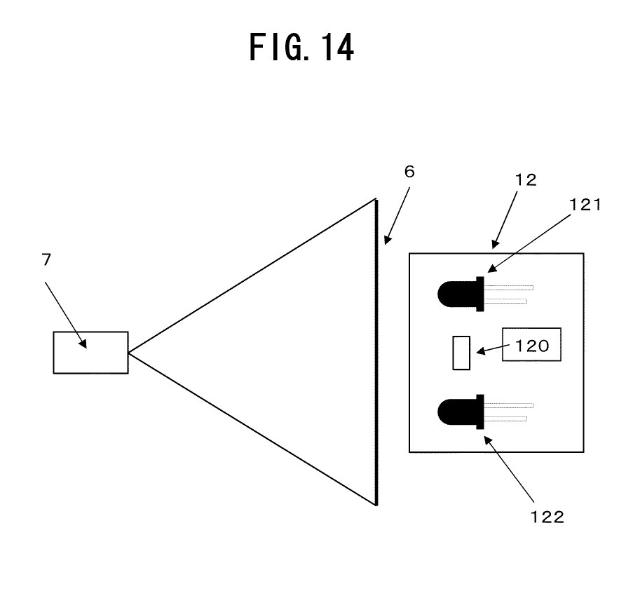

FIG. 14 shows a light emitting device 12 of the illegal recording prevention apparatus having the above-mentioned mechanism. A light emitting element 121 which emits infrared light having the center wavelength in the 900-980 nm range, the light emitting element 122 which emits the infrared light having the center wavelength in the 800-900 nm, and a sensor unit 120 which detects the brightness of a theater screen 6, are built in the light emitting device 12. The light emitting element 121 always emits infrared light having the center wavelength in the 900-980 nm range, and when the sensor unit 120 judges that the screen is bright, the light emitting element 122 also emits infrared light having the center wavelength in the 800-900 nm. This allows radiation selection of infrared light automatically, so that the apparatus capable of preventing illegal recording can be offered without having a bad influence on watching the movie. Moreover, a sensor in which visibility compensation is carried out in order to judge the intensity of the infrared light to human's eyes is suitably used as the sensor unit 120.

It is desirable that the detection of the sensor unit 120 not be carried out during a period when the infrared light is emitted from the illegal recording prevention apparatus. This is because the sensor unit 120 may judge the brightness of the screen incorrectly if the infrared light having the center wavelength in the 900-980 nm emitted from the light emitting element 121 is reflected on the screen and is detected by the sensor unit 120. Therefore, when, in fact, the sensor unit 120 detects the brightness of the screen before the infrared light is emitted from the illegal recording prevention apparatus, and judges that the screen is bright enough, the infrared light having the center wavelength in the 800-900 nm is emitted.

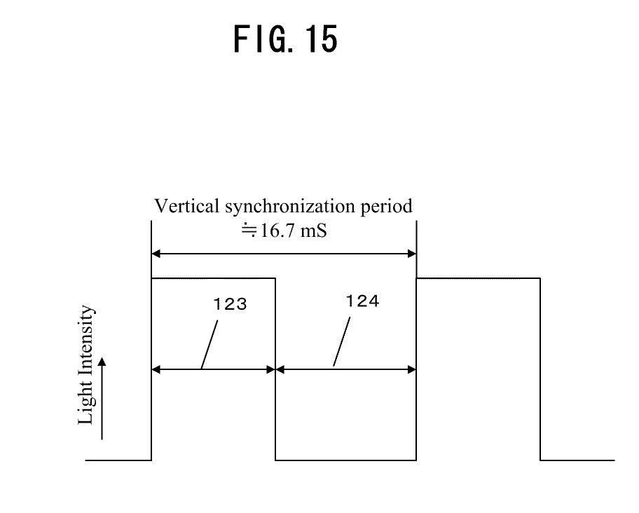

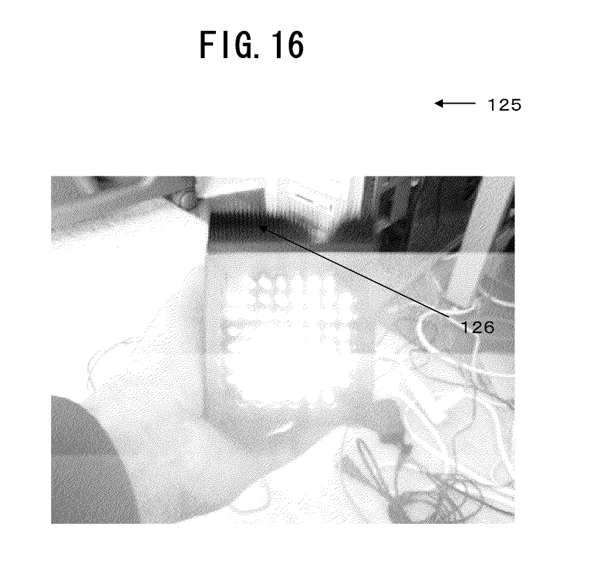

Moreover, as shown in FIG. 15, light is emitted in a period 123 of a light emission period, which is shorter than a vertical-synchronization period, at the frequency of about 60 Hz which is near the vertical synchronous frequency of a video signal. If the light emission is stopped in a period 124, since, as shown in FIG. 16, stripes are shown in an image taken with the video camera and the image can not be worthy watching the movie, the illegal recording prevention effect can be acquired.

In FIG. 16, light emission is stopped at a position 125 distant from a top edge of the image, while the illegal recording prevention apparatus emits light, during the period from the position 125 to the bottom edge of the image. As shown in FIG. 16, since an operation of an auto iris cannot catch up therewith, white halation has arisen so that the image is hard to be seen. Although it is driven at the frequency near a vertical synchronizing signal, since it differs from vertical synchronous frequency, the position of light emission and light off varies in each frame, so that strong flicker arises in the image which was illegally recorded, whereby the image is hard to be seen. The reference 126 indicate a prototype of the illegal recording prevention apparatus, in FIG. 16.

The preceding description has been presented only to illustrate and describe exemplary embodiments of the present illegal recording prevention apparatus according to the present invention. It is not intended to be exhaustive or to limit the invention to any precise form disclosed. It will be understood by those skilled in the art that various changes may be made and equivalents may be substituted for elements thereof without departing from the scope of the invention. In addition, many modifications may be made to adapt a particular situation or material to the teachings of the invention without departing from the essential scope. Therefore, it is intended that the invention not be limited to the particular embodiment disclosed as the best mode contemplated for carrying out this invention, but that the invention will include all embodiments falling within the scope of the claims. The invention may be practiced otherwise than is specifically explained and illustrated without departing from its spirit or scope.

What is claimed is:

1. An illegal recording prevention apparatus used for preventing an illegal recording with a video camera in a movie theater, comprising:
means for emitting infrared light which has a center wavelength in a wavelength of 800-980 nm wavelength,
so that an automatic-focusing regulating function or automatic exposure regulating function of the video camera is deteriorated.

2. The illegal recording prevention apparatus according to claim 1, wherein the infrared light is emitted intermittently.

3. The illegal recording prevention apparatus according to claim 1, wherein data is output by controlling intervals of blinking infrared light.

4. The illegal recording prevention apparatus according to claim 1, wherein remote control data of the video camera is overlapped on the infrared light.

5. The illegal recording prevention apparatus according to claim 1, further including a sensor unit which detects brightness of a theater screen, wherein when the sensor unit judges that the theater screen is dark, the infrared light which has a center wavelength in a 900-980 nm range is emitted, and when the sensor unit judges the theater screen is bright, the infrared light which has a center wavelength in a 800-900 nm range is also emitted in addition thereto.

6. The illegal recording prevention apparatus according to claim 1, wherein the sensor unit stops detection, in a period when the infrared light is emitted towards the video camera.

7. The illegal recording prevention apparatus according to claim 1, wherein during light emission, the infrared light is emitted at a frequency of about 60 Hz.
